(19) United States
(12) Patent Application Publication
(10) Pub. No.: US 2012/0164381 A1
(43) Pub. Date: Jun. 28, 2012

(54) IN-MOLD COATED ARTICLES HAVING CONTROLLED SURFACE MORPHOLOGY AND ASSOCIATED METHODS FOR MANUFACTURING SAME

(76) Inventors: Paul Morgan, Evansville, IN (US); Brodie Wright, Evansville, IN (US)

(21) Appl. No.: 13/270,821

(22) Filed: Oct. 11, 2011

Related U.S. Application Data
(60) Provisional application No. 61/391,719, filed on Oct. 11, 2010.

(51) Int. Cl. B32B 3/00; B28B 7/38

(52) U.S. Cl. 428/141; 427/133

(57) ABSTRACT

An in-mold coated article that includes at least one of a controlled surface morphology and a predetermined color which is manufactured via a single- or multi-coat process. The in-mold coated article preferably resembles wood, leather, marble, granite, clay, etcetera.

The present invention further provides methods for manufacturing in-mold coated articles using single-coat and/or multi-coat processes as disclosed herein.

### CROSS-REFERENCE TO RELATED APPLICATION(S)

This application claims the benefit of U.S. Provisional Application Ser. No. 61/391,719, filed Oct. 11, 2010, entitled “In-Mold Coated Articles Having Controlled Surface Morphology and Associated Methods for Manufacturing Same,” which is hereby incorporated herein by reference in its entirety, including all references cited therein.

### BACKGROUND OF THE INVENTION

1. Field of the Invention

The present invention relates in general to in-mold coated articles for use in, for example, residential, commercial, industrial, and/or military products in any one of a number of industries, including, but not limited to, aerospace, automotive, construction, furniture, health care, and/or marine industries—just to name a few. More particularly, the present invention relates to in-mold coated articles, which comprise novel controlled surface morphologies and/or color and which resemble a plurality of other materials, including, for example, wood, animal skin (e.g., leather), natural stone or rock (e.g., marble, granite), natural minerals (e.g., clay), etcetera.

2. Background Art

In-mold coated articles and associated technology have been known in the art for several years. See, for example, U.S. Pat. No. 6,656,596 entitled “Decorative Automotive Interior Trim Articles with Cast Integral Light Stable Covering and Process for Making the Same,” U.S. Pat. No. 5,906,788 entitled “Dual Cure, In-Mold Process for Manufacturing Abrasion Resistant, Coated Thermoplastic Articles,” U.S. Pat. No. 5,662,996 entitled “Method for Manufacturing Self-Supporting Synthetic Trim Parts and Thus Manufactured Trim Parts,” U.S. Pat. No. 5,418,032 entitled “Vehicle Interior Door Panel,” U.S. Pat. No. 5,411,688 entitled “Method for Forming Plastic Molded Panels with Inserts,” U.S. Pat. No. 5,242,738 entitled “Surface Layer of Interior Article,” U.S. Pat. No. 4,902,578 entitled “Radiation-Curable Coating for Thermoplastic Substrates,” U.S. Pat. No. 4,830,803 entitled “Method of Making a Molded Article of Methacrylic Resin,” U.S. Pat. No. 3,248,467 entitled “Molding Process,” U.S. Patent Application Publication No. 2003/0104168 A1 entitled “In-Mold-Coated Automotive Interior and Other Products, and Methods for Manufacturing Same,” European Patent Application No. 1,079,962 B1 entitled “Decorative Automotive Interior Trim Articles with Integral In-Mold Coated Polyurethane Aromatic Elastomer Covering and Process for Making the Same,” and International Publication No. WO 99/61216 entitled “Decorative Automotive Interior Trim Articles with Integral In-Mold Coated Polyurethane Aromatic Elastomer Covering and Process for Making the Same,” all of which are hereby incorporated herein by reference in their entirety—including all references cited therein.

While the utilization of in-mold coated articles has become increasingly popular in several industries, issues associated with controlling the surface morphology (e.g., texture, grain, finish, appearance) color, and/or feel remain largely problematic.

Indeed, to the best of Applicant's knowledge, prior to the present invention controlling the surface morphology of in-mold coated articles was limited to variables in tool design or coating spray methods, such as spatter coating. Although these tools and/or spraying methods could produce some differential surface morphologies, they were problematically deficient in their ability to resemble and/or mimic the surface morphology of several popular substrates.

It is therefore an object of the present invention, among other objects, to provide novel in-mold coated articles which comprise novel controlled surface morphologies and/or color which resemble materials, including, for example, wood, leather, marble, granite, clay, etcetera. It is also an object of the present invention to provide methods for manufacturing such novel in-mold articles in a repeatable manner.

These and other features, advantages, and objects of the present invention will be further understood and appreciated by those skilled in the art by reference to the following specification, claims, and appended drawings.

### SUMMARY OF THE INVENTION

The present invention is directed to an in-mold coated article, which comprises at least one of controlled surface morphology and color via a single- or multi-coat process. In this embodiment, the in-mold coated article preferably resembles wood, leather, marble, granite, clay, etcetera.

The present invention is also directed to a multi-coat method for manufacturing an in-mold coated article, comprising the steps of: (a) applying a first coat of material to at least a portion of a tool surface; (b) applying a second coat of material to at least a portion of the tool surface and the first coat material; and (c) associating a substrate with the first and second coat material to, in turn, generate an in-mold coated article having a controlled surface morphology.

The present invention is further directed to a single-coat method for manufacturing an in-mold coated article, comprising the steps of: applying a first coat of material to at least a portion of a tool surface; and associating a substrate with the first coat material to, in turn, generate an in-mold coated article having a controlled surface morphology.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a perspective representation of an in-mold coated article fabricated in accordance with the present invention; and

FIG. 2 of the drawings is a perspective representation of an in-mold coated article fabricated in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

In accordance with the present invention, in-mold coated articles are disclosed herein which comprise controlled surface morphologies and/or color via a single- or multi-coat process. The surface morphologies preferably resemble wood, leather, marble, granite, clay, etcetera—even though the articles are preferably fabricated from polyurethane (e.g., sprayskin, foam, RIM, slush TPU), vinyl (e.g., slush vinyl), thermoplastic polyolefin, among others.

The multi-coat process for fabricating the in-mold coated article (in this example a two-coat process) comprises applying a first coat of material to at least a portion of a traditional tool surface. Preferably the first coat (i.e., top coat) is applied by spraying material onto the tool surface. However, any one of a number of application methods are likewise contemplated for use in accordance with the present invention. It will be understood that the first coat material preferably exhibits a substantial inability to effectively flow and/or level out over the tool surface. Preferably, the inability of the first coat material to flow and level over the tool is rooted in surface energy differential flow chemistry. The differential flow may be due to any number of surface tension related issues, including, but not limited to: (1) the use of an external release agent with relatively low surface energy (silicones, fluoropolymers, polyethylene waxes, PTFE waxes, paraffin waxes, etcetera)—such a low surface energy is believed to creates a surface on the tool that is difficult for certain types of coatings to wet and flow over; (2) high solids solventborne 2K reactive coatings based on low molecular weight oligomers and polymers and without flow additives so that there is not a sufficient surface tension lowering effect from solvents or additives to lower the surface energy of the coating sufficiently to flow and/or level over the metal tool; and (3) waterborne 2K coatings based on low molecular weight oligomers and polymers and without flow additives so that there is not a sufficient surface tension lowering effect from solvents or additives to lower the surface energy of the coating sufficiently to flow and/or level over the metal tool.

In accordance with the present invention, the controlled inability of the first coating to wet the surface of the tool can lead to any number of surface tension differential flow effects such as, (1) a complete beading up of the coating particles, leaving most of the tool surface exposed, (2) partial coverage with a moderate amount of the tool surface exposed (creeping and/or crawling), and (3) significant tool coverage with some significant cratering, pinholing, and fish-eyes, that allow very small portions of the tool to be exposed.

In a preferred embodiment of the present invention, the first coat material is prepared in such a manner that it can be sprayed with a second coating within approximately 30 seconds to approximately 90 seconds (depending on the exact process) with no issues of adhesion or film defects on the final in-mold coated article or part.

Examples of suitable first coat materials preferably include lower molecular weight polyols—especially those that are liquid phase under typical ambient conditions. Such polyols may be reacted with a polyisocyanate in a 2K formulation, whereby incorporation of a urethane catalyst is preferred to insure desired dry times for the entire in-mold cycle. It will be understood that first coat materials can be either waterborne or solventborne—as long as they prescribe to the aforementioned conditions. While specific first coat materials have been disclosed herein above, it will be understood than other materials that would be known to those having ordinary skill in the art having the present disclosure before them are likewise contemplated for use.

The second step in the multi-coat process comprises applying a second coat of material to at least a portion of the traditional tool surface and the first coat material. Unlike the first coat material, the second coat material preferably achieves substantially comprehensive and/or continuous coverage of the tool and first coat material—while gaining good adhesion to the first coat material sprayed into the tool. It will be understood that the second coat material may comprise, for example, Red Spot 458W, as well as a plurality of other compositions, including 2K waterbornes, 1K waterbornes based on PUD's, acrylics, and/or cationic stabilized dispersions.

Preferably, the second coat material dries sufficiently fast to comport with net processing time—approximately 30 seconds to approximately 5 minutes.

After the second coat material is applied, a substrate (e.g., polyurethane or vinyl) is associated with the first and second coat materials using conventional IMC techniques.

After the entire article or part has been molded and released from the tool a coated (finished) article is obtained having a controlled surface morphology (i.e., special effect), color and/or feel on the outer surface of the article. The controlled surface morphology is generally defined by the second coating being observable in varying degrees under the first coating. The precise surface morphology is preferably determined by the amount of tool that is left exposed after spraying the first coating in the tool. By way of example, the more that the tool is left exposed, the more the second coat is observed on the finished part. As such, on parts where the first coating beads up significantly on the tool, large sections of the second coat can be seen. Similarly, when only a few sections of the tool are left exposed after the first coat, a very small amount of the second can be seen visually on the finished article. The end effect is an article that has a nearly unlimited number of visual effects or surface morphologies based on several factors including: (1) the color contrast between the first coat and second coat; (stark contrasts can be generated as can subtle color differences that lead to a visual “depth” not achievable with the current in-mold coating processes; (2) the degree to which the first coat covers and thus the degree to which the second coat can be seen on the final part; and (3) the grain and effects of the actual tool in combination with the two-coat process described in this invention.

In accordance with the present invention, additional coats beyond the first and second coats are likewise contemplated for use so long as the desired surface morphology is obtained.

The present invention is also directed to a single-coat process for fabricating an in-mold coated article having controlled surface morphology. In this embodiment the substrate is directly associated with the first coat without the second coat.

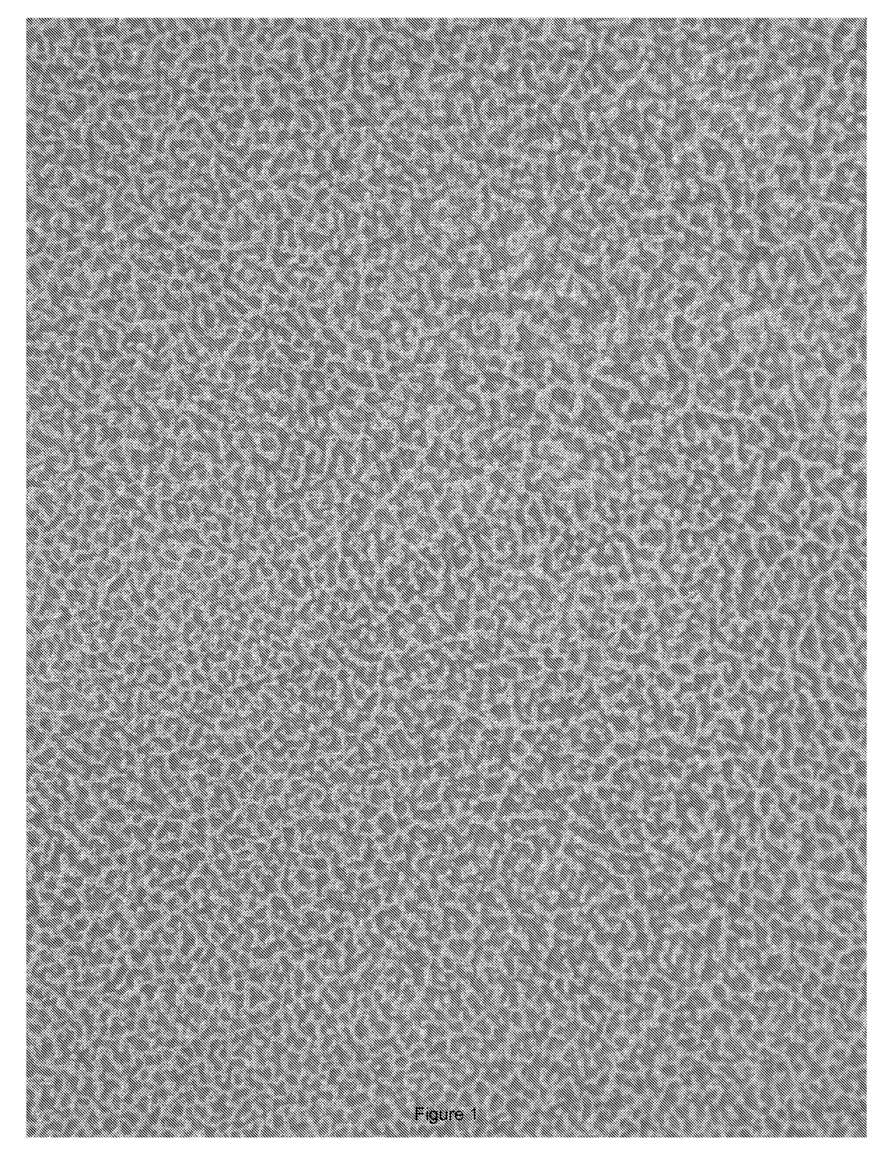

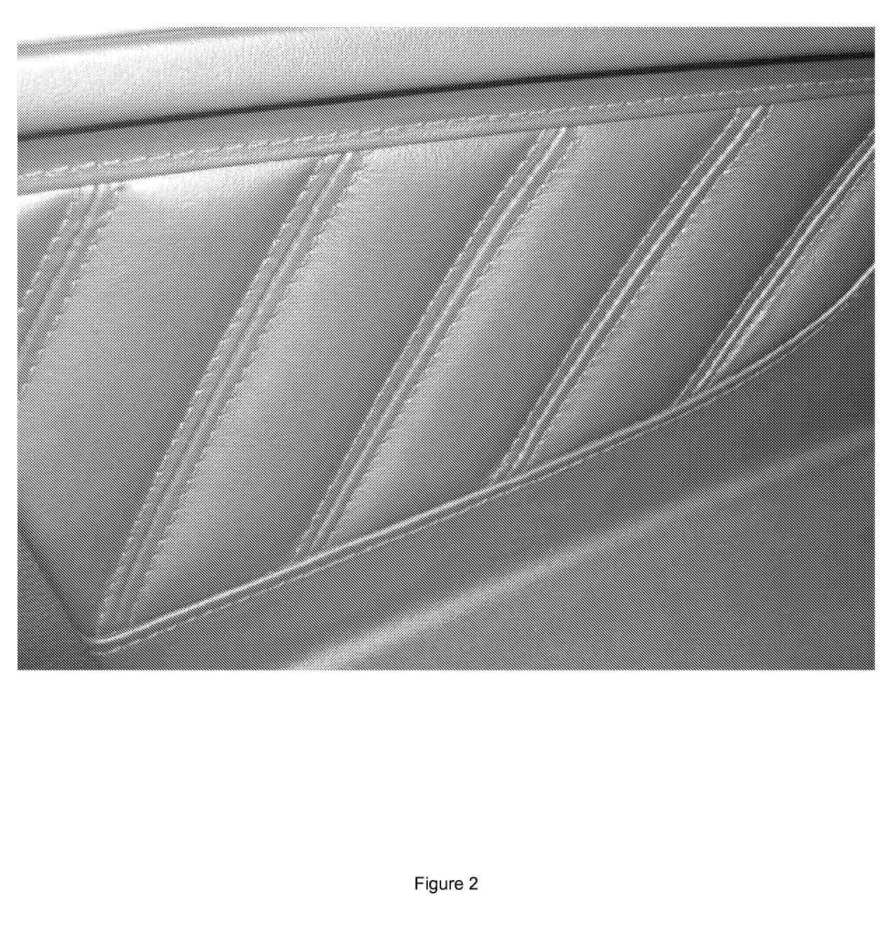

Referring now to the collective drawings FIGS. 1 and 2 are perspective views of in-mold coated articles having controlled surface morphologies fabricated in accordance with the present invention using a multi-step process.

While the invention has been described in detail herein in accordance with certain preferred embodiments thereof, many modifications and changes therein may be effected by those skilled in the art. Accordingly, it is our intent to be limited only by the scope of the appending claims and not by way of details and instrumentalities describing the embodiments shown herein.

What is claimed and desired to be secured by Letters Patent of the United States is:

1. An in-mold coated article, comprising:
an inner surface and an outer surface, wherein at least one of the inner and outer surfaces comprise at least one of a controlled surface morphology and a predetermined color, said in-mold coated article manufactured via a single- or multi-coat process.

2. The in-mold coated article according to claim 1, wherein the outer surface comprises a controlled surface morphology which resembles at least one of the group consisting of wood, leather, marble, granite, clay, and combinations thereof.

3. A multi-coat method for manufacturing an in-mold coated article, comprising the steps of:
applying a first coat of material to at least a portion of a tool surface;
applying a second coat of material to at least a portion of the tool surface and the first coat material; and
associating a substrate with the first and second coat materials to, in turn, generate an in-mold coated article having a controlled surface morphology.

4. A single-coat method for manufacturing an in-mold coated article, comprising the steps of:
applying a first coat of material to at least a portion of a tool surface; and
associating a substrate with the first coat material to, in turn, generate an in-mold coated article having a controlled surface morphology.
